(19) United States
(12) Patent Application Publication
(10) Pub. No.: US 2025/0265509 A1
(43) Pub. Date: Aug. 21, 2025

(54) IN-VEHICLE INVENTORY AND RENTAL SYSTEM

(71) Applicant: Ford Global Technologies, LLC, Dearborn, MI (US)

(72) Inventors: Brendan F. Diamond, Grosse Pointe, MI (US); Keith Weston, Canton, MI (US); Michael Alan McNees, Flat Rock, MI (US); Anthony Maraldo, Southgate, MI (US); Andrew Denis Lewandowski, Sterling Heights, MI (US); Jordan Barrett, Milford, MI (US)

(21) Appl. No.: 18/582,119

(22) Filed: Feb. 20, 2024

(51) Int. Cl. G06Q 10/02; B60J 3/04; B60Q 9/00; B60R 25/01; B60R 25/24; B60W 60/00; G06Q 50/47; G06V 20/59; G06V 40/10; G07C 9/00

(52) U.S. Cl. CPC G06Q 10/02; B60J 3/04; B60Q 9/00; B60R 25/01; B60R 25/24; B60W 60/00253; G06Q 50/47; G06V 20/593; G06V 40/10; G07C 9/00309; B60R 2325/205; G07C 2009/00793

(57) ABSTRACT

Sharing seating zones of a vehicle as office space is provided. A share request is received from a user device of a user requesting a seating zone from a listing of available shares. A vehicle received from a rental server, a reservation of the seating zone of the vehicle. Access to the seating zone is provided in accordance with the reservation.

### TECHNICAL FIELD

Aspects of the disclosure generally relate to an in-vehicle inventory and rental system.

### BACKGROUND

A vehicle user may have many items in their vehicle which are not being used and not expected to be used. These items may be utilized by other individuals if the vehicle user is willing for the item to be rented and the item is not in use.

### SUMMARY

In one or more illustrative examples, a method for sharing seating zones of a vehicle as office space includes receiving, to a vehicle from a rental server, a reservation of a seating zone of the vehicle, responsive to a share request requesting the seating zone being received from a user device of a user from a listing of available shares; and providing access to the seating zone in accordance with the reservation.

In one or more illustrative examples, a system for sharing seating zones of a vehicle as office space, comprising a rental server including one or more hardware computing devices, the rental server being configured to execute a sharing service to perform operations including to receive share data from a plurality of vehicles, the share data indicating office features of the seating zones; compile a listing of available shares based on the share data; receive a share request requesting a seating zone from a user device of a user from a listing of available shares, the share request indicating one or more requirements for office features to be available in the seating zone, the office features being independent of location of the vehicle; filter the listing of available shares based on the requirements; receive an indication of a selected vehicle of the plurality of vehicles from the user device; send, to the selected vehicle, a reservation of the seating zone of the vehicle and a credential for access to the seating zone, and send, to the user device, the credential for access to the seating zone, the credential to be provided from the user device to the vehicle to grant access to the seating zone, wherein the vehicle is configured to provide access to the seating zone in accordance with the reservation responsive to validating the credential received to the vehicle from the user device.

In one or more illustrative examples, a non-transitory computer-readable medium comprising instructions that, when executed by one or more hardware computing devices, cause the one or more hardware computing devices to perform operations including to receive share data from a plurality of vehicles, the share data indicating office features of seating zones of the respective vehicles; compile a listing of available shares based on the share data; receive a share request requesting a seating zone from a user device of a user, the share request including a listing of one or more requirements for the office features to be available in the seating zone; filter the listing of available shares based on the requirements; receive an indication of a selected vehicle of the plurality of vehicles from the user device; send, to the selected vehicle, a reservation of the seating zone of the vehicle and a credential for access to the seating zone, and send, to the user device, the credential for access to the seating zone, the credential to be provided from the user device to the vehicle to grant access to the seating zone.

### BRIEF DESCRIPTION OF THE DRAWINGS

FIG. 1 illustrates an example system for using vehicles for the sharing of inventory items, storage locations, and seating locations for mobile office rental space;

FIG. 2 illustrates an example process for the use of the system for the sharing of inventory items of a vehicle;

FIG. 3 illustrates an example process for the use of the system for the sharing of storage locations of a vehicle;

FIG. 4 illustrates an example process for the use of the system for the sharing of seating locations of a vehicle as office space; and

FIG. 5 illustrates an example computing device for performing aspects of the sharing of inventory items, storage locations, and seating locations.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It may be desirable for a vehicle to act as an item rental depot. Additionally, people cities are always on the move and often walk from place to place due to lack of ownership of a vehicle or to avoid traffic. Finding a place to work between destinations may be difficult. Coffee shops and other public work hubs may become crowded and/or noisy. Moreover, such locations may expose valuable company information while the user is in a meeting or working on a project. A vehicle inventory, charge, and mobile office rental system may utilize user input, the interior and/or exterior sensor suite, and items that are available in the vehicle that are not being used to facilitate the rental of items and vehicle space. Further aspects of the disclosure are discussed in detail herein.

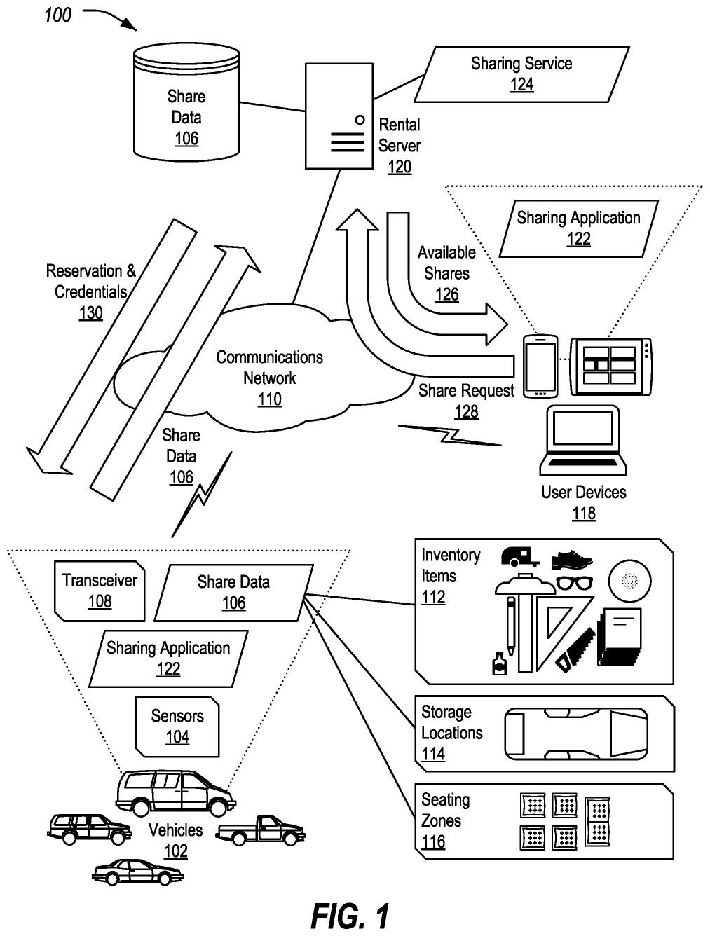

FIG. 1 illustrates an example system 100 for using vehicles 102 for the sharing of inventory items 112, storage locations 114, and seating zones 116 for mobile office rental space. The vehicles 102 may include sensors 104 configured to monitor the operation of the vehicles 102 for use in generating share data 106. The vehicles 102 may also include transceivers 108 for communication over the communications network 110. The share data 106 may be indicative of the status of inventory items 112, storage locations 114, and/or seating zones 116 of the vehicle 102. The system 100 may also include user devices 118 and a rental server 120, each configured for communication over the communications network 110. A sharing application 122 may be installed to the vehicles 102 and/or to the user devices 118. A sharing service 124 may be installed to the rental server 120. The rental server 120 may be configured to receive share data 106 from the vehicles 102, indicate available shares 126 to the user devices 118, receive share requests 128 from the user devices 118, and provide reservations and/or credentials 130 to the vehicles 102 to perform the sharing. It should be noted that the illustrated system 100 is only an example, and systems 100 having more, fewer, or different components may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be a battery electric vehicle (BEV) powered by a traction battery and one or more electric motors. As a further possibility, the vehicle 102 may be a hybrid electric vehicle powered by both an internal combustion engine, a traction battery, and one or more electric motors. Hybrid vehicles 102 may come in various forms, such as a series hybrid electric vehicle, a parallel hybrid electrical vehicle, or a parallel/series hybrid electric vehicle. Vehicles 102 may be associated with unique identifiers, such as vehicle identification numbers (VINs), globally unique identifiers (GUIDs), customer or fleet accounts, etc.

The sensors 104 may include devices of the vehicle 102 configured to measure quantities relevant to operation of the vehicle 102, as well as to provide a data signal to the vehicle 102 to inform the vehicle 102 regarding the measured quantities. The sensors 104 may include, as some non-limiting examples, speed sensors, pedal position sensors, temperature sensors, seat pressure sensors, global navigation satellite system (GNSS) sensors, infrared image sensors, visible light image sensors, light detection and ranging (LIDAR) sensors, radio detection and ranging (RADAR) sensors, door lock sensors, etc.

The share data 106 may include static information about the capacities and capabilities of the vehicle 102. As the type and configuration of vehicle 102 may vary, the capabilities of the vehicle 102 may correspondingly vary. As some possibilities, vehicles 102 may have different capabilities with respect to passenger capacity, towing ability and capacity, and storage. This information may be stored to the vehicles 102 as share data 106. The share data 106 may indicate, for example, how many seating locations available, etc.

The share data 106 may also include dynamic information about the vehicle 102 determined using the sensors 104. For example, the share data 106 may indicate, based on the sensors 104, which seating locations are occupied, where the vehicle 102 is located, the current heading and/or speed of the vehicle 102, whether the doors of the vehicle 102 are locked, images of the interior and/or exterior of the vehicle 102, etc.

The vehicle 102 may include a transceiver 108 to send data from the vehicle 102 as well as to receive data to the vehicle 102. The transceiver 108 may a wireless transceiver for communication over the communications network 110. The communications network 110 may include one or more interconnected communication networks such as the Internet, a cable television distribution network, a satellite link network, a local area network, and a telephone network, as some non-limiting examples. In another example, the transceiver 108 may additionally or alternatively utilize other communications protocols such as a BLUETOOTH or BLUETOOTH Low Energy (BLE) transceivers, ultrawide band (UWB), Wi-Fi, etc., for communications with various devices.

The vehicle 102 may contain or be connected to various inventory items 112. These inventory items 112 may include: tools, extension cords, golf clubs, baseball bats, tennis rackets, sunglasses, umbrellas, water tubes, ice skates, roller blades, spare tires, wheels, compressor kits, bikes, kayaks, canoes, trailers, etc. The inventory items 112 may remain in the vehicle 102 when it is not being used and not expected to be used. Yet, the inventory items 112 may be utilized by other individuals if the user of the vehicle 102 is willing for the item to be rented and the item is not in use.

The sensors 104 may be used by the vehicle 102 to determine the presence of the inventory items 112. In an example, the sensors 104 may capture images from which image recognition techniques may be performed to determine the presence of various items of the inventory items 112 in the vehicle 102. Additionally or alternatively, tow sensors 104 or electrical wiring of the vehicle 102 may be used to sense the presence of various items of inventory items 112.

The vehicle 102 may also include one or more vehicle storage locations 114. These storage locations 114 may include, as some non-limiting examples, the trunk of the vehicle 102, the frunk of the vehicle 102, seating zones 116 of the vehicle 102, lockers installed to the vehicle 102, a trailer of the vehicle 102, etc. The sensors 104 may also be used by the vehicle 102 to determine the presence of inventory items 112 or other items within the storage locations 114.

The vehicle 102 may also include one or more seating zones 116. These seating zones 116 may include, as some non-limiting examples, front row seats, second row seats, third row seats, the truck bed, a trailer, etc. The sensors 104 may also be used by the vehicle 102 to determine the presence of occupants, inventory items 112, or other items within the seating zones 116.

The users of the system 100 may carry or otherwise be associated with user devices 118. The user devices 118 may include various brought-in devices that may be carried into the vehicle 102 interior by a user. Examples of such user devices 118 may include laptop computers, tablet devices, smartphones, smart rings or other wearables, personal digital assistants (PDAs), virtual reality (VR) headsets, smart speaker devices, as some non-limiting possibilities.

The rental server 120 may be an example of a networked computing device that is accessible to the vehicles 102, inventory items 112, and/or user devices 118 over the communications network 110. The rental server 120 may be configured to send and receive various data elements from and to the other elements of the system 100. A sharing application 122 may be an example of an application that is executed by one or more computing devices of the vehicle 102 and/or the user devices 118. A sharing service 124 may be an example of an application executed by the rental server 120.

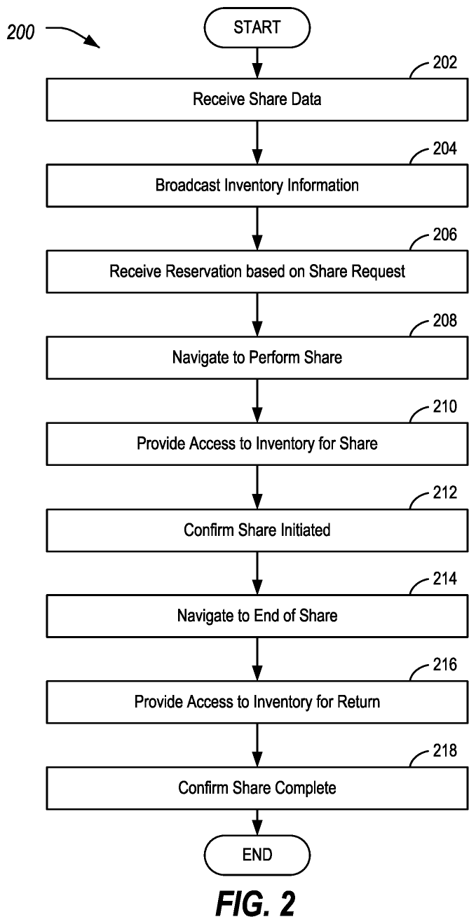

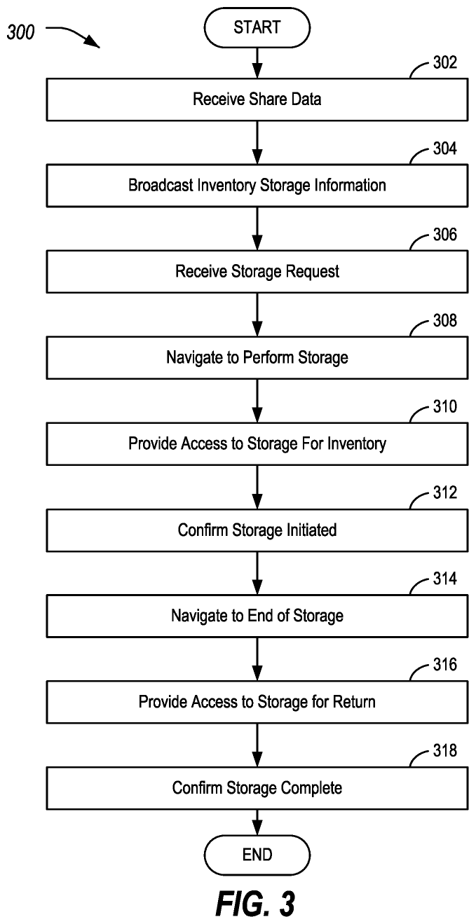

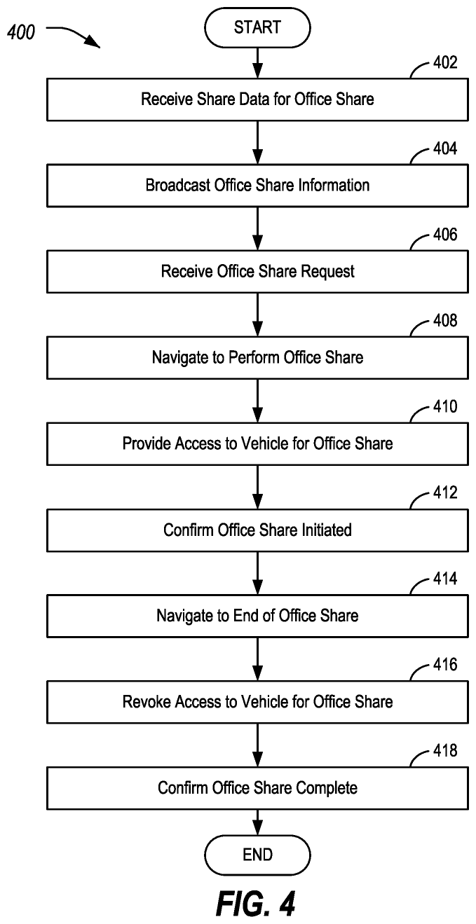

The sharing application 122 of the vehicle 102 and/or user devices 118 operating in combination with the sharing service 124 of the rental server 120 may include instructions that, when executed by the respective devices, perform the operations discussed in detail herein. For instance, a user may utilize the user device 118 to receive a listing of available shares 126. The available shares 126 may indicate inventory items 112, storage locations 114, and/or seating zones 116 that are compiled by the sharing service 124 based on the share data 106 and available for sharing via the rental server 120. Based on the available shares 126, the user device 118 may send a share request 128 to the rental server 120. The rental server 120 may accordingly provide a reservation and/or credentials 130 to the vehicle 102 to perform the share. As some specific examples, these operations may include, for example, for the sharing of inventory items 112 as discussed with respect to FIG. 2, the sharing of storage locations 114 as discussed with respect to FIG. 3, and/or the sharing of seating zones 116 as discussed with respect to FIG. 4.

FIG. 2 illustrates an example process 200 for the use of the system 100 for the sharing of inventory items 112 of a vehicle 102. The process 200 may allow the user of the vehicle 102 to share inventory items 112 that are available in the vehicle 102 and not being used.

At operation 202, the vehicle 102 determines which inventory items 112 in the vehicle 102 can be rented out and/or purchased. In an example the sensors 104 of the vehicle 102 may be used for identifying which inventory items 112 are present in or connected to the vehicle 102. For instance, internal sensors 104 and image recognition may be used to identify inventory items 112 within the cabin, trunk, and./or frunk of the vehicle 102, while external sensors 104 may be used to determine whether a trailer or other inventory items 112 area attached to the exterior of the vehicle 102.

In another example, the vehicle 102 may receive user input from an owner or other operator of the vehicle 102 indicating the inventory items 112 that is available for rental and/or sale. In yet another example the vehicle 102 may receive user input with respect to which of the detected inventory items 112 are available.

For each item, the vehicle 102 may also receive share data 106 indicating parameters of the sharing of the inventory items 112. The share data 106 may indicate aspects of how the system 100 should allow the rental and/or sale of the inventory items 112. In one example, the share data 106 may include a rental fee. The rental fee may be a flat rate fee, based on a periodic basis such as hourly, based on a value of the item (e.g., if broken or not returned), etc.

The share data 106 may also define a return policy regarding if the inventory items 112 is to be borrowed but is not returned back to the vehicle 102 within a specified time duration. The return policy may specify, for example, that the borrowing user may have to pay the value of the item to the owner if the inventory items 112 is not returned.

The share data 106 may also specify whether the inventory items 112 is to be returned to the vehicle 102 by a specific time range and/or specific location (e.g., if the vehicle 102 is routed to move, to be returned to another vehicle 102, to be returned to a locker, building or other fixed location, to be pass along to a next user, etc.).

Based on the detected and/or entered items, at operation 204 the vehicle 102 may indicate which inventory items 112 are available for rent. Share data 106 with respect to the inventory items 112 may be sent to the rental server 120 and/or broadcast locally, to inform other users of the available items. For instance, the information about available inventory items 112 may be displayed as alerts to the user device 118. Or a browse interface may be displayed by the user device 118 to allow the user to search and locate available inventory items 112. In another example, the vehicle 102 may utilize external displays on the vehicle 102 to visually inform passersby of the inventory items 112. In yet another example, the vehicle 102 may use exterior speakers to audibly inform passersby of the inventory items 112.

At operation 206, the vehicle 102 receives a share request 128. In an example, the user device 118 may receive available shares 126 from the rental server 120. The renting user may choose to rent an inventory item 112 and may use the user device 118 to select the inventory item 112 from the available shares 126. This selection may include accepting any associated fees, agreement, policies, etc. for the rental.

At operation 208, the vehicle 102 navigates to perform the share. In an example, the vehicle 102 may receive the reservation and/or credential 130 from the rental server 120. Based on the reservation, the vehicle 102 may use autonomous driving functionality to relocate itself closer to areas or specific regions where the inventory items 112 may be required. In another example, the rental server 120 may send a location of the vehicle 102 to the user device 118 to allow the renting user to locate the inventory item 112. This may allow the vehicle 102 and/or the renting user to meet to allow for the retrieval of the inventory item 112.

At operation 210, the vehicle 102 provides access to the inventory item 112 to be shared. In an example, the vehicle 102 may use the sensors 104 to confirm the identity of the renting user. For instance, the vehicle 102 may perform facial recognition to confirm the identity of the renting user. In such a case, prior to providing entry into vehicle 102, the vehicle 102 may use its sensors 104 in combination with additional devices in the system 100 to confirm specific aspects of the renting user. In an example, camera sensors 104 of the vehicle 102 embedded in the B-pillar (or other vehicle camera) may be used to capture an image of the user, which may be sent to the rental server 120 for the performance of image recognition to verify the identify of the user. Additionally or alternatively, face print data to allow the vehicle 102 to recognize the user may be provided to the vehicle 102, to allow the vehicle 102 (or a mobile edge computing (MEC) device in communication with the vehicle 102) to perform the identity validation.

In another example, the vehicle 102 may receive a pin, fingerprint, voice print, or other biometric data from the rental server 120 and may compare the entered pin or biometric to ensure the identity of the user. In yet another example, the rental server 120 may provide the vehicle 102 and the user device 118 with a temporary phone-as-a-key (PAAK) credential 130, and communication between the vehicle 102 and the user device 118 of the credential 130 may be used to authorize access to the inventory item 112 of the vehicle 102.

Responsive to granting the access, the vehicle 102 may unlock and/or open a closure, lock box, item rental box, etc., to allow the renting user to retrieve the inventory item 112. The closure may be a location of the vehicle 102, such as the bed, a frunk, a trunk, a separate lock box where only a specific set of inventory items 112 are available, etc.

At operation 212, the vehicle 102 confirms that the share is initiated. In an example, the vehicle 102 uses the sensors 104 to monitor the renting user to ensure that the renting user is only retrieving the inventory item 112 for the share. If the shared item is not taken, then the vehicle 102 may indicate to the rental server 120 that the share is canceled. If other items are taken instead of or in addition to the inventory item 112 for the share, the vehicle 102 may alert the user device 118 and/or the rental server 120 of the discrepancy. This may allow the renting user to correct the issue, as perhaps the renting user retrieved the wrong inventory item 112 or inventory items 112. Or, this may also allow the system 100 to raise an alert if unauthorized inventory items 112 are taken intentionally.

A similar process may be performed for return of the inventory item 112. At operation 214, the vehicle 102 navigates to perform the return. This may include autonomous movement of the vehicle 102 and/or providing directions to the vehicle 102 to the user device 118 of the renting user. It should be noted that, in some examples, the vehicle 102 to which the inventory item 112 is to be returned may be a different vehicle 102 as compared to the vehicle from which the inventory item 112 is rented.

At operation 216, the vehicle 102 provides access for the inventory item 112 to be returned. In an example, the access may be granted similar to as discussed above with respect to operation 210. For instance, the same pin PAAK credential 130, etc. may be used to grant the access. Or in other examples, new pins or other credentials 130 may be supplied from the rental server 120 to the user device 118 to facilitate the return.

Responsive to granting the access, the vehicle 102 may unlock and/or open a closure, lock box, item rental box, etc., to allow the renting user to return the inventory item 112. The closure may be a location of the vehicle 102, such as the bed, a frunk, a trunk, a separate lock box where only a specific set of inventory items 112 are available, etc.

At operation 218, the vehicle 102 confirms the share is complete. In an example, the vehicle 102 may use the sensors 104 to confirm that the correct inventory item 112 was returned. This also allow the system 100 to raise an alert if unauthorized inventory items 112 are takin intentionally.

Variations on the process 200 are possible. It should be noted that if the share transaction is a purchase transaction and not a borrow transaction, then the item may not be required to be returned. If so, then operations 214-218 may not be performed. Such an example may include, for example where a refrigerated frunk storage of the vehicle 102 is used to offer cold items such as beverages for sale. In such an example, external displays of the vehicle 102 may be used to advertise the inventory items 112 for sale.

In some examples, one or more theft prevention features may be implemented to ensure the smooth operation of the vehicle 102 in dispensing and receiving the inventory items 112. For instance, prior to being given the location of the vehicle 102, the user device 118 of the borrowing user may be required to provide a confirmed image identification of the borrowing user. For example, the rental server 120 may indicate a gesture to be performed by the user in an image for verification purposes. The borrowing user may be required to provide an image using the user device 118 that matches the requested gesture. Responsive to the rental server 120 receiving an image of the requested gesture, the rental server 120 may then send the location of the vehicle 102 to the user device 118.

In some examples, the share and/or return may be conditional on the renting user being the only detected user. For instance, if the vehicle 102 identifies, using the sensors 104, that more than one person is in the vicinity of the vehicle 102, then further operations may be performed to ensure the security of the inventory item 112. As one possibility, a user device 118 approach may be used to allow the renting user picking up the inventory items 112 to either take responsibility for the other people in the vicinity (and anything they might do or take), verify the other person in the vicinity, or wait until those other persons depart.

In some examples, the return of the inventory item 112 may include image recognition and/or a two-way camera sharing using the sensors 104 to allow the renting user to verify the condition of the inventory items 112 being returned. This may allow the owner to confirm that the inventory items 112 that were borrowed are returned in a clean, undamaged, functioning, etc. state. As one possibility, the rental server 120 may broker an approval process via the user device 118 by which the inventory items 112 to be returned are confirmed or rejected by the owner.

In some examples, rather than return of the inventory item 112 to the owner, the inventory item 112 may be passed along to a third party, such as a second renting user or a new owner. In such an example, similar image recognition or confirmation procedures between the giving and receiving users may be used to facilitate the transaction. In yet another possibility, the borrower may simply deliver the inventory item 112 between vehicles 102 without using the inventory item 112. In such a case, the borrower may be a simple delivery person, and may in some examples be compensated for performing the delivery, e.g., as specified in the share data 106.

FIG. 3 illustrates an example process 300 for the use of the system 100 for the sharing of storage locations 114 of a vehicle 102. The process 300 may be similar to the process 200 discussed in detail above. However, instead of inventory items 112, it is available storage locations 114 for inventory items 112 that is mediated by the system 100. Thus, the techniques discussed above may be used, in an example, for temporary storage of inventory items 112.

At operation 302 and similar to operation 202, the vehicle 102 determines which storage locations 114 of the vehicle 102 can be rented out for storage of inventory items 112. In an example, the sensors 104 of the vehicle 102 may be used for identifying which storage locations 114 are available in the vehicle 102. For instance, internal sensors 104 and/or image recognition may be used to identify empty seating, available trunk space, available frunk space, available trailer space in trailers attached to the vehicle 102, etc. In another example, the vehicle 102 may receive user input from an owner or other operator of the vehicle 102 indicating the storage locations 114 that are available for rental. In yet another example the vehicle 102 may receive user input with respect to which of the detected storage locations 114 are available.

At operation 304 and similar to operation 204, the vehicle 102 may indicate which storage locations 114 are available for rent for inventory items 112. For instance, share data 106 with respect to the inventory items 112 may be sent to the rental server 120 and/or broadcast locally, to inform other users of the available storage locations 114.

At operation 306 and similar to operation 206, the vehicle 102 receives a storage share request 128. In an example, the user device 118 may send the storage share request 128 to the rental server 120. A storing user may choose to rent a storage location 114 of a vehicle 102 and may use the user device 118 to select the vehicle 102 and accept any associated fees, agreement, policies, etc. for the rental.

At operation 308 and similar to operation 208, the vehicle 102 navigates to perform the storage. In an example, the vehicle 102 may use autonomous driving functionality to relocate itself closer to areas or specific regions where the storage locations 114 may be required. In another example, the rental server 120 may send a location of the vehicle 102 to the user device 118 to allow the storing user to locate the vehicle 102 into which the inventory item 112 can be placed. This may allow the vehicle 102 and/or the renting user to meet to allow for the storing of the inventory item 112.

At operation 310 and similar to operation 210, the vehicle 102 provides access to the storage locations 114 to store inventory items 112. In an example, the vehicle 102 may receive a pin, fingerprint, voice print, or other biometric data from the rental server 120 and may compare the entered pin or biometric to ensure the identity of the user. Responsive to granting the access, the vehicle 102 may unlock and/or open a closure, lock box, item rental box, etc., to allow the renting user to store the inventory item 112.

At operation 312 and similar to operation 212, the vehicle 102 confirms that the storage operation is initiated. In an example, the vehicle 102 uses the sensors 104 to monitor the storing user to ensure that the storing user is placing the inventory item 112 into the storage location 114 that is authorized for the storing.

A similar process may be performed for retrieval of the inventory item 112 from the storage. At operation 314 and similar to operation 214, the vehicle 102 navigates to perform the retrieval from the storage location 114. This may include autonomous movement of the vehicle 102 and/or providing directions to the vehicle 102 to the user device 118 of the storing user. It should be noted that, in some examples, the user to which the inventory item 112 is to be retrieved may be a different user as compared to the user who stored the inventory item 112 to the vehicle 102.

At operation 316 and similar to operation 216, the vehicle 102 provides access to the storage location 114 for the inventory item 112 to be removed. In an example, the access may be granted similar to as discussed above with respect to operations 210 and 310.

At operation 318 and similar to operation 218, the vehicle 102 confirms the storage is complete. In an example, the vehicle 102 may use the sensors 104 to confirm that the correct inventory item 112 was removed from the correct storage location 114.

In an example, if a user is at the beach and wants to store their valuables in a vehicle 102, a verification and/or identification of the inventory items 112 may be used to catalog the inventory items 112 and their condition. Once identified, the inventory items 112 may be stored in a vehicle 102 while that person is enjoying the beach. Once the storage is complete, access can be granted to the user's inventory items 112 using access techniques discussed above, such as facial image recognition, fingerprint detection, voice print detection, pin entry, PAAK credentials 130, etc. to identify the returning user.

Dedicated storage locations 114 can be offered where a frunk or trunk can be dedicated to a person's belongings. A live camera feed may can be offered from the sensors 104 for piece-of-mind to the person renting the storage location 114. The inventory items 112 in the storage location 114 may be listed for sale. Agreements may be made to place an inventory item 112 in the storage for pick up at a different location.

In another variation, the system 100 may be used for scheduling vehicle-to-vehicle charging. Vehicle-based charging may be offered, for example, at tailgating venues or at a beach or park where a user of a vehicle 102 wants to charge a user device 118 or another vehicle 102. A charger integrated within the vehicle 102, such as in a trunk or frunk, may be used to facilitate the charging. The trunk or frunk may be secured and may be opened similar to providing access to storage and/or to inventory items 112 as discussed in detail above. In addition, the credentials 130 aspects may be used to ensure that only authorized devices may be charged. For instance, similar to as noted above, the vehicle 102, may require biometrics, a pin, a PAAK certificate, etc. to allow the charging to be activated.

Further variations may be performed to ensure schedule coordination. For example, the vehicle 102 may be agreed to be maintained in a parked location for a prescribed period of time, e.g., for pickup, drop off, or storage of inventory items 112. However, in some cases, the vehicle 102 may be required to be moved, such as to make way for a priority vehicle 102 (such as an ambulance) that is giving aid. In such a situation, the rental server 120 may manage changing the vehicle 102 location, and to arrange an updated return of borrowed inventory items 112 or withdrawal from the storage location 114.

As noted above, people in larger cities are always on the move and often walk from place to place due to lack of ownership of a vehicle 102 or to avoid traffic. Or people may be traveling and be located in another city where they do not have a vehicle 102 to drive or office to attend. Finding a place to work in such a location may be difficult. Coffee shops and other public work hubs may become crowded or noisy or may expose valuable company information while in a meeting or working on a project.

FIG. 4 illustrates an example process 400 for the use of the system 100 for the sharing of seating zones 116 of a vehicle 102 as office space. In such an example, users may be able to rent vehicles 102 to use as a temporary office location. In many examples, the office rental vehicles 102 may be parked, but in some instances it is possible that the rented vehicles 102 may be in transit.

In the vehicle 102 office, in-vehicle work surfaces such as tables may provide a work surface. In another example, mobile hot spots may allow users to connect to the Internet. In another example, heating, ventilation, and air conditioning (HVAC) and other vehicle controls may be used to set to comfort settings. In another example, charging features and/or electrical outlets may be offered to ensure that the user devices 118 are powered. In yet another example, the vehicle 102 may carry office supplies such as pens, paper, etc. Additionally, the infotainment system of the vehicle may offer white noise and/or noise cancelation to allow for improved concentration and/or secured access to classified information. In some examples, microphones, cameras, speakers, touchscreens, keypads, etc. located within the cabin of the vehicle 102 may be available for being plugged into or paired with or otherwise being made available for use in connection with the user's electronics.

In some examples, the vehicle 102 interior may have various features that may be useful as an office environment. For example, the vehicle 102 may have seats that are maneuverable to recline, move forwards or backwards, swivel to face towards or away from one another, or otherwise be configurable to be positioned into orientations and positions useful for meetings, working in front of a desk, facilitating a video call, or other office tasks.

In some examples, the vehicle 102 may have windows with an electro-chromatic tint feature, allowing the windows to darken the vehicle interior to a defined brightness. Additionally, or alternately, the vehicle 102 may include light sensors within the vehicle cabin, such that the window tint can be altered and/or the vehicle 102 can be instructed to be moved to a location with reduced sun load exposure.

In some examples, the vehicle 102 may have specific approved uses and rules to be monitored and enforced using the sensors 106 of the vehicle 102. If a non-approved usage is identified, then warnings may be provided and/or cancelation of the rental may result. In an example, approved usage may include use of a computer or drawing, while a non-approved use may include preparing or drinking beverages, smoking, sound above a predefined dB level, etc.

At operation 402 and similar to operations 202 and 302, the vehicle 102 determines which seating zones 116 of the vehicle 102 can be rented out for use as office space. For instance, internal sensors 104 and/or image recognition may be used to identify empty seating zones 116 of the vehicle 102, etc. In another example, the vehicle 102 may receive user input from an owner or other operator of the vehicle 102 indicating the seating zones 116 that are available for rental. In yet another example the vehicle 102 may receive user input with respect to which of the detected seating zones 116 are available.

At operation 404 and similar to operations 204 and 304, the vehicle 102 indicates which seating zones 116 are available for rent. For instance, share data 106 with respect to the seating zones 116 may be sent to the rental server 120 and/or broadcast locally, to inform other users of the available seating zones 116.

At operation 406 and similar to operations 206 and 306, the vehicle 102 receives an office space share request 128. In an example, the user device 118 may send the office space share request 128 to the rental server 120. The share request 128 may include requirements of the user for the office features to be available in the seating zone 116. These requirements may generally be independent of the location of the vehicle 102. As some non-limiting examples, the requirements may include one or more of availability of Wi-Fi, availability of a table, availability of a conference call speaker device, and/or availability of a privacy sound zone. As some further examples, the requirements may include swiveling chairs for a conference, presence of built in web conference equipment (such as cameras, microphones and speakers), maximum light level inside the vehicle, maximum sound level inside the vehicle, etc. An office worker user may choose to rent a seating zone 116 of a vehicle 102 and may use the user device 118 to select the vehicle 102 and accept any associated fees, agreement, policies, etc. for the rental.

At operation 408 and similar to operations 208 and 308, the vehicle 102 navigates to perform the office share of the seating zone 116. In an example, the vehicle 102 may use autonomous driving functionality to relocate itself closer to areas or specific regions where the seating zones 116 may be required. In another example, the rental server 120 may send a location of the vehicle 102 to the user device 118 to allow the office space requesting user to locate the vehicle 102 to use as a temporary office. This may allow the vehicle 102 and/or the office space user to meet to allow for the use of the seating zone 116.

At operation 410 and similar to operations 210 and 310, the vehicle 102 provides access to the seating zone 116 to be shared. In an example, the vehicle 102 may use the sensors 104 to confirm the identity of the office space user. For instance, the vehicle 102 may receive a pin, fingerprint, voice print, or other biometric data from the rental server 120 and may compare the entered pin or biometric to ensure the identity of the user. Responsive to granting the access, the vehicle 102 may unlock and/or otherwise provide access to the seating zone 116.

At operation 412 and similar to operations 212 and 312, the vehicle 102 confirms that the office share of the seating zone 116 is initiated. In an example, the vehicle 102 uses the sensors 104 to monitor the office space user to confirm that the office space user is using the correct seating zone 116 that is authorized for use. If the user is in the wrong seat, then the vehicle 102 may inform the user. In some examples, the selected seating zone 116 for the office space user may be indicating using features of the vehicle 102, such as cabin lighting or speakers, to provide an indication to the user of the correct seating zone 116.

At operation 414 and similar to operations 214 and 314, the vehicle 102 navigates (if necessary) to perform the end of the office share. In many examples, the office share may be performed by the vehicle 102 at a fixed location. However, in some examples, the vehicle 102 may also combine a travel task with the office space task, and may allow the user to travel to a destination while also offering office services.

At operation 416 and similar to operations 216 and 316, the vehicle 102 revokes access to the seating zones 116 for the office share to be completed. At operation 418 and similar to operations 218 and 318, the vehicle 102 confirms the office share is complete. In an example, the vehicle 102 may use the sensors 104 to confirm that the user has left the seating zone 116 and has not left inventory items 112 behind.

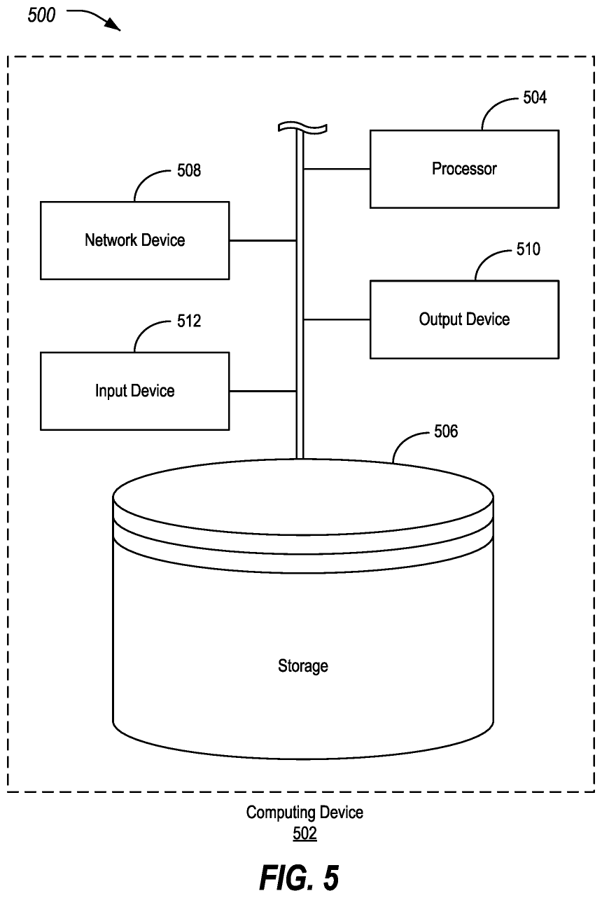

FIG. 5 illustrates an example computing device 502 for performing aspects of the sharing of inventory items 112, storage locations 114, and seating zones 116. Referring to FIG. 5, and with reference to FIGS. 1-4, the vehicles 102, sensors 104, transceivers 108, inventory items 112, user devices 118, and rental server 120 may include examples of such computing devices 502. Computing devices 502 generally include computer-executable instructions, such as those of the sharing application 122 and sharing service 124, where the instructions may be executable by one or more computing devices 502. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as the share data 106, may be stored and transmitted using a variety of computer-readable media.

As shown, the computing device 502 may include a processor 504 that is operatively connected to a storage 506, a network device 508, an output device 510, and an input device 512. It should be noted that this is merely an example, and computing devices 502 with more, fewer, or different components may be used.

The processor 504 may include one or more integrated circuits that implement the functionality of a central processing unit (CPU) and/or graphics processing unit (GPU). In some examples, the processors 504 are a system on a chip (SoC) that integrates the functionality of the CPU and GPU. The SoC may optionally include other components such as, for example, the storage 506 and the network device 508 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 504 executes stored program instructions that are retrieved from the storage 506. The stored program instructions, accordingly, include software that controls the operation of the processors 504 to perform the operations described herein. The storage 506 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 510. The output device 510 may include a graphical or visual display device, such as an electronic display screen, projector, printer, or any other suitable device that reproduces a graphical display. As another example, the output device 510 may include an audio device, such as a loudspeaker or headphone. As yet a further example, the output device 510 may include a tactile device, such as a mechanically raisable device that may, in an example, be configured to display braille or another physical output that may be touched to provide information to a user.

The input device 512 may include any of various devices that enable the computing device 502 to receive control input from users. Examples of suitable input devices 512 that receive human interface inputs may include keyboards, mice, trackballs, touchscreens, microphones, graphics tablets, and the like.

The network devices 508 may each include any of various devices that enable the described components to send and/or receive data from external devices over networks. Examples of suitable network devices 508 include an Ethernet interface, a Wi-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for sharing seating zones of a vehicle as office space, comprising:
receiving, to a vehicle from a rental server, a reservation of a seating zone of the vehicle, responsive to a share request requesting the seating zone being received from a user device of a user from a listing of available shares; and
providing access to the seating zone in accordance with the reservation.

2. The method of claim 1, further comprising:
receiving a credential to the vehicle from the rental server for providing the access to the vehicle;
validating the credential by the vehicle as entered by the user of the user device, the credential being provided to the user via the user device; and
granting the access to the seating zone responsive to the credential being validated.

3. The method of claim 1, further comprising indicating the seating zone using cabin lights or speakers the vehicle.

4. The method of claim 1, further comprising:
verifying that the user is in the seating zone using sensors of the vehicle; and
responsive to the user being in an incorrect seating zone, indicating the seating zone that is correct for the user using cabin lights or speakers the vehicle.

5. The method of claim 1, further comprising:
receiving, from each of a plurality of vehicles, share data indicative of seating zones of the respective vehicles that are available, the share data indicating office features of the seating zones; and
compiling the listing of available shares based on the share data.

6. The method of claim 5, further comprising:
receiving from the user device, a listing of one or more requirements for the office features to be available in the seating zone, the office features being independent of location of the vehicle; and
filtering the listing of available shares based on the requirements.

7. The method of claim 6, wherein the requirements include one or more of availability of Wi-Fi, availability of a table, availability of a conference call speaker device, availability of a conference call microphone device, availability of a conference call camera device, and/or availability of charging features or electrical outlets.

8. The method of claim 6, wherein the requirements include availability of a privacy sound zone.

9. The method of claim 6, wherein the requirements include availability of swiveling seats to allow for a face-to-face conference.

10. The method of claim 6, wherein the requirements include a defined brightness, and further comprising one or more of:
utilizing an electro-chromatic tint feature of windows of the vehicle to darken the vehicle interior to the defined brightness; or
autonomously moving the vehicle moved to a location with reduced sun load exposure to meet the defined brightness.

11. The method of claim 1, wherein the share request indicates a location for the vehicle, and further comprising one or more of navigating the vehicle to the location or navigating the user to the location.

12. The method of claim 1, wherein the share request indicates a pickup location and a dropoff location, and further comprising responsive to detecting the user as having entered the vehicle, navigating the vehicle from the pickup location to the dropoff location.

13. A system for sharing seating zones of a vehicle as office space, comprising:
a rental server including one or more hardware computing devices, the rental server being configured to execute a sharing service to perform operations including to:
receive share data from a plurality of vehicles, the share data indicating office features of the seating zones;
compile a listing of available shares based on the share data;
receive a share request requesting a seating zone from a user device of a user from a listing of available shares, the share request indicating one or more requirements for the office features to be available in the seating zone, the office features being independent of location of the vehicle;
filter the listing of available shares based on the requirements;
receive an indication of a selected vehicle of the plurality of vehicles from the user device;
send, to the selected vehicle, a reservation of the seating zone of the vehicle and a credential for access to the seating zone, and
send, to the user device, the credential for access to the seating zone, the credential to be provided from the user device to the vehicle to grant access to the seating zone,
wherein the vehicle is configured to provide access to the seating zone in accordance with the reservation responsive to validating the credential received to the vehicle from the user device.

14. The system of claim 13, wherein the vehicle is further configured to indicate the seating zone using cabin lights or speakers the vehicle.

15. The system of claim 13, wherein the vehicle is further configured to:
verify that the user is in the seating zone using sensors of the vehicle; and
responsive to the user being in an incorrect seating zone, indicate the seating zone that is correct for the user using cabin lights or speakers the vehicle.

16. The system of claim 13, wherein the requirements include one or more of availability of Wi-Fi, availability of a table, availability of a conference call speaker device, availability of a conference call microphone device, availability of a conference call camera device, availability of charging features or electrical outlets, availability of a privacy sound zone, and/or availability of swiveling seats to allow for a face-to-face conference.

17. The system of claim 13, wherein the requirements include a defined brightness, and further comprising one or more of:
utilizing an electro-chromatic tint feature of windows of the vehicle to darken the vehicle interior to the defined brightness; or
autonomously moving the vehicle moved to a location with reduced sun load exposure to meet the defined brightness.

18. The system of claim 13, wherein the share request indicates a location for the vehicle, and wherein one or more of: the vehicle is configured to navigate to the location or the user device is configured to navigate the user to the location.

19. The system of claim 13, wherein the share request indicates a pickup location and a dropoff location, and the vehicle is configured to, responsive to detecting the user as having entered the vehicle, navigate the vehicle from the pickup location to the dropoff location.

20. A non-transitory computer-readable medium comprising instructions that, when executed by one or more hardware computing devices, cause the one or more hardware computing devices to perform operations including to:
receive share data from a plurality of vehicles, the share data indicating office features of seating zones of the respective vehicles;
compile a listing of available shares based on the share data;
receive a share request requesting a seating zone from a user device of a user, the share request including a listing of one or more requirements for the office features to be available in the seating zone;
filter the listing of available shares based on the requirements;
receive an indication of a selected vehicle of the plurality of vehicles from the user device;
send, to the selected vehicle, a reservation of the seating zone of the vehicle and a credential for access to the seating zone, and
send, to the user device, the credential for access to the seating zone, the credential to be provided from the user device to the vehicle to grant access to the seating zone.
